(19) United States
(12) Patent Application Publication
(10) Pub. No.: US 2024/0343626 A1
(43) Pub. Date: Oct. 17, 2024

(54) GLASS MATERIAL PRODUCING METHOD AND GLASS MATERIAL

(71) Applicant: NIPPON ELECTRIC GLASS CO., LTD., Otsu-shi, Shiga (JP)

(72) Inventor: Tomoko ENOMOTO, Otsu-shi (JP)

(21) Appl. No.: 18/683,312

(22) PCT Filed: Aug. 17, 2022
(86) PCT No.: PCT/JP2022/031002

§ 371 Date: Feb. 13, 2024

(30) Foreign Application Priority Data
Aug. 23, 2021 (JP) 2021-135672

(51) Int. Cl. C03B 5/00; C03B 32/00

(52) U.S. Cl. CPC C03B 5/00; C03B 32/00; C03B 2211/00

(57) ABSTRACT

Provided is a method for producing a glass material whereby a glass material less likely to undergo solarization can be obtained. A method for producing a glass material includes the steps of: preparing a glass; and subjecting the glass to heat treatment for six or more hours at a temperature of not lower than (Tg−70°) C and not higher than (Tg+40°) C where a glass transition point of the glass is represented as Tg (° C.).

### TECHNICAL FIELD

The present invention relates to methods for producing glass materials. The present invention also relates to glass materials.

### BACKGROUND ART

In recent years, studies on containerless levitation techniques as methods for producing glass materials are being conducted. For example, Patent Literature 1 describes a method for vitrifying a barium-titanium-based ferroelectric sample by heating the barium-titanium-based ferroelectric sample levitated in an aerodynamic levitation furnace to melting by irradiation with a laser beam and then cooling it. The containerless levitation techniques can reduce the progress of crystallization of a material due to contact with the wall surface of a container in the above manner and, therefore, may be able to vitrify even materials that could not be vitrified by conventional production methods using containers. Hence, the containerless levitation techniques are noteworthy as methods enabling the production of glass materials having novel compositions.

Furthermore, Patent Literature 2 discloses a method for producing a glass material by a containerless levitation technique using, as a block of glass raw material, a block of crystals obtained by cooling a melt of raw material batch.

### CITATION LIST

### Patent Literature

[PTL 1]
JP-A-2006-248801
[PTL 2]
JP-A-2015-059074

### SUMMARY OF INVENTION

### Technical Problem

The containerless levitation techniques can vitrify even materials that previously would be difficult to vitrify. However, conventional glass materials produced by the containerless levitation techniques may undergo solarization (coloration) when left in a bright place, such as under sunlight or under a fluorescent light.

An object of the present invention is to provide a method for producing a glass material whereby a glass material less likely to undergo solarization can be obtained. Furthermore, an object of the present invention is to provide a glass material less likely to undergo solarization.

### Solution to Problem

A method for producing a glass material according to the present invention includes the steps of: preparing a glass; and subjecting the glass to heat treatment for six or more hours at a temperature of not lower than (Tg-70°) C and not higher than (Tg+40°) C where a glass transition point of the glass is represented as Tg (° C.)

In the method for producing a glass material according to the present invention, the glass preferably contains, in terms of % by mole, not less than 50% La₂O₃+Gd₂O₃+Y₂O₃+Yb₂O₃+Ga₂O₃+TiO₂+ZrO₂+Nb₂O₅+Ta₂O₅+WO₃ and not more than 50% B₂O₃+SiO₂+P₂O₅+GeO₂.

In the method for producing a glass material according to the present invention, the glass preferably contains, in terms of % by mole, 10% or more La₂O₃.

In the method for producing a glass material according to the present invention, the step of preparing a glass preferably includes the steps of: heating a block of glass raw material held levitated, thus obtaining a molten glass melted from the block of glass raw material by the heating; and cooling the molten glass to obtain a glass.

The method for producing a glass material according to the present invention is preferably a method for producing a glass material for use as an optical glass material.

A glass material according to the present invention is a glass material which contains, in terms of % by mole, not less than 50% La₂O₃+Gd₂O₃+Y₂O₃+Yb₂O₃+Ga₂O₃+TiO₂+ZrO₂+Nb₂O₅+Ta₂O₅+WO₃ and not more than 50% B₂O₃+SiO₂+P₂O₅+GeO₂ and in which, when the glass material is subjected to light irradiation of light having a wavelength of 280 nm to 400 nm at an irradiance of 0.1 mW/cm² to 10 mW/cm² for 24 hours to 100 hours, an absolute value Δb* of a difference between a first chromaticity b* of the glass material before the light irradiation in an L*a*b* color system and a second chromaticity b* of the glass material after the light irradiation in the L*a*b* color system is 0.5 or less.

The glass material according to the present invention preferably contains, in terms of % by mole, 10% or more La₂O₃.

The glass material according to the present invention is preferably an optical glass material.

### Advantageous Effects of Invention

The present invention enables provision of a method for producing a glass material whereby a glass material less likely to undergo solarization can be obtained. Furthermore, the present invention enables provision of a glass material less likely to undergo solarization.

### BRIEF DESCRIPTION OF DRAWINGS

FIG. 1 is a schematic cross-sectional view showing an example of a production apparatus for producing a glass by a containerless levitation technique.

FIG. 2 is a graph showing a first example of a time chart of heating temperature applicable in subjecting a glass to heat treatment in the present invention.

FIG. 3 is a graph showing a second example of a time chart of heating temperature applicable in subjecting a glass to heat treatment in the present invention.

FIG. 4 is a graph showing a third example of a time chart of heating temperature applicable in subjecting a glass to heat treatment in the present invention.

FIG. 5 is a graph showing a fourth example of a time chart of heating temperature applicable in subjecting a glass to heat treatment in the present invention.

### DESCRIPTION OF EMBODIMENTS

Hereinafter, a description will be given of a preferred embodiment. However, the following embodiment is merely illustrative and the present invention is not limited to the following embodiment. Throughout the drawings, members having substantially the same functions may be referred to by the same reference characters.

### (Method for Producing Glass Material)

A method for producing a glass material according to the present invention includes the steps of: preparing a glass; and subjecting the glass to heat treatment for six or more hours at a temperature of not lower than (Tg−70°) C and not higher than (Tg+40°) C where the glass transition point of the glass is represented as Tg (° C.)

Containerless levitation techniques can vitrify even a composition that could not be vitrified by a melting method using a container. However, when a conventional glass produced by such a containerless levitation technique is left in a bright place, it may undergo solarization, such as taking on a yellow tinge. Unlike the above, in the present invention, even a glass produced by a containerless levitation technique can be less likely to undergo solarization.

The method for producing a glass material according to the present invention can suitably produce, for example, a barium titanate-based glass material, a lanthanum-niobium composite oxide-based glass material, a lanthanum-tungsten composite oxide-based glass material, a lanthanum-titanium composite oxide-based glass material, a lanthanum-tantalum composite oxide-based glass material, a lanthanum-gallium composite oxide-based glass material, a lanthanum-aluminum composite oxide-based glass material, a lanthanum-boron composite oxide-based glass material, and so on and can make it less likely that these glass materials undergo solarization.

The method for producing a glass material according to the present invention is preferably a method for producing a glass material for use as an optical glass material (i.e., a method for producing an optical glass material).

### <Step of Preparing Glass>

A glass to be prepared is preferably a glass produced by a containerless levitation technique. Herein, the glass to be prepared may also be described as a “precursor glass”. For example, a conventionally known glass produced by a containerless levitation technique can be used as the above glass (precursor glass). The containerless levitation technique is a technique of heating a block of glass raw material held levitated, thus obtaining a molten glass melted from the block of glass raw material by the heating; and cooling the molten glass to obtain a glass.

Specifically, the above step of preparing a glass preferably includes the steps of: heating a block of glass raw material held levitated, thus obtaining a molten glass melted from the block of glass raw material by the heating; and cooling the molten glass to obtain a glass.

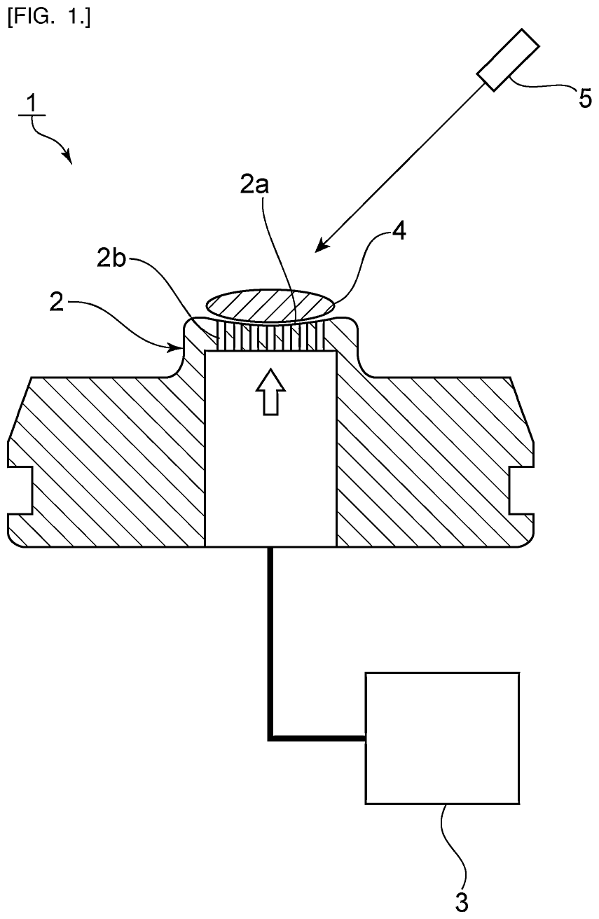

FIG. 1 is a schematic cross-sectional view showing an example of a production apparatus for producing a glass by a containerless levitation technique.

A production apparatus 1 for glass (precursor glass) shown in FIG. 1 includes a forming mold 2. The forming mold 2 includes a forming surface 2a and a plurality of gas jet holes 2b opening on the forming surface 2a. The forming surface 2a is a curved surface. Specifically, the forming surface 2a has the shape of a spherical surface. The gas jet holes 2b are connected to a gas supply mechanism 3, such as a compressed gas cylinder. Gas is supplied from this gas supply mechanism 3 via the gas jet holes 2b to the forming surface 2a. The type of the gas is not particularly limited. Examples of the gas include air, oxygen, nitrogen gas, argon gas, helium gas, carbon monoxide gas, and carbon dioxide gas.

In producing a glass using the production apparatus 1, first, a block of glass raw material being an object 4 to be levitated is levitated above the forming surface 2a by jetting out the gas through the gas jet holes 2b opening on the forming surface 2a of the forming mold 2. In other words, the block of glass raw material as the object 4 to be levitated is held out of contact with the forming surface 2a.

Examples of the block of glass raw material include a body obtained by forming glass raw material powder into a single mass by press molding or other processes, a sintered body obtained by forming glass raw material powder into a single mass by press molding or other processes and then sintering the single mass, and an aggregate of crystals having the same composition as a desired glass composition. The shape of the block of glass raw material is not particularly limited and examples include a lens shape, a spherical shape, a columnar shape, a polygonal prism shape, a cuboid shape, and an oval spherical shape.

Next, while the block of glass raw material is held levitated as the object 4 to be levitated, it is irradiated with laser light from a laser light applicator 5. Thus, the block of glass raw material is heated to melting, thereby obtaining a molten glass. Next, the molten glass is cooled while being held levitated, so that a glass can be obtained.

The shape, size, and so on of the glass are not particularly limited.

### <Step of Subjecting to Heat Treatment>

The above glass (precursor glass) is subjected to heat treatment for six or more hours at a temperature of not lower than (Tg−70°) C and not higher than (Tg+40°) C where the glass transition point of the glass is represented as Tg (° C.). Glasses produced by containerless levitation techniques are generally those having compositions that cannot be vitrified by melting methods and the like. Glasses produced by containerless levitation techniques tend to have a sparse glass structure. The inventor found that when glass is heated under the above-described heat treatment conditions, the glass structure becomes dense and consequently the glass can be less likely to undergo solarization. Therefore, the method for producing a glass material according to the present invention can suitably produce a glass material less likely to undergo solarization, even using as the above glass (precursor glass) a glass having a sparse structure other than glasses produced by containerless levitation techniques.

The glass transition point of the above glass can be measured with a macro differential thermal analyzer. Specifically, in a chart obtained by measuring the glass up to 1000° C. with a macro differential thermal analyzer, the value of a first inflection point can be considered as the glass transition point.

The heating temperature of the glass in the above-described heat treatment conditions is not lower than (Tg−70°) C and not higher than (Tg+40°) C, preferably not lower than (Tg−50°) C, and preferably not higher than (Tg+20° C.) When the heating temperature is not lower than the above lower limit, the effects of the present invention can be more effectively exerted and the heat treatment time can be shortened. When the heating temperature is not higher than the above upper limit, the effects of the present invention can be more effectively exerted and devitrification of the resultant glass material can be effectively prevented.

The heating time of the glass in the above-described heat treatment conditions is six or more hours, preferably not less than nine hours, more preferably not less than 12 hours, preferably not more than 100 hours, and more preferably not more than 30 hours. When the heating times is not less than the above lower limit, the effects of the present invention can be more effectively exerted. When the heating time is not more than the above upper limit, the production time can be reduced and devitrification of the resultant glass material can be effectively prevented.

The above glass may be subjected to heat treatment continuously for six or more hours at temperatures of not lower than (Tg−70°) C and not higher than (Tg+40°) C or may be subjected to heat treatment discontinuously for six or more hours at the temperatures. In the present invention, the total time to subject the glass to heat treatment within a temperature range of not lower than (Tg−70°) C and not higher than (Tg+40°) C only has to be six or more hours.

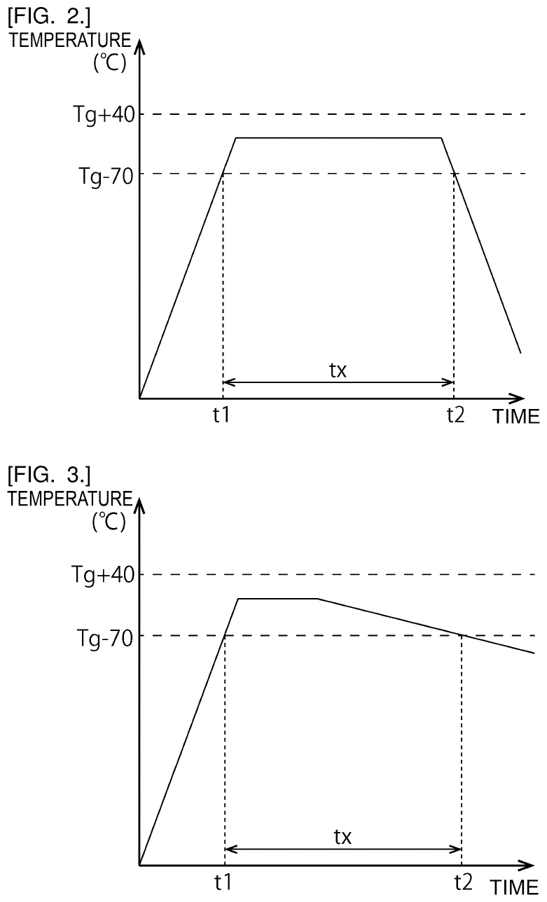

FIG. 2 is a graph showing a first example of a time chart of heating temperature applicable in subjecting a glass to heat treatment in the present invention.

In FIG. 2, the glass is heated at a constant rate of temperature increase, then held at a constant temperature, and then cooled at a constant rate of temperature decrease. In FIG. 2, the time when a temperature of (Tg−70°) C has been reached during temperature increase is represented as t1, the time when a temperature of (Tg−70°) C has been reached during temperature decrease is represented as t2, and the time from t1 to t2 is represented as tx. In FIG. 2, the time (tx) for which the glass is subjected to heat treatment at temperatures of not lower than (Tg−70°) C and not higher than (Tg+40°) C is six or more hours.

FIG. 3 is a graph showing a second example of a time chart of heating temperature applicable in subjecting a glass to heat treatment in the present invention.

In FIG. 3, the glass is heated at a constant rate of temperature increase, then held at a constant temperature, and then cooled at a constant rate of temperature decrease. In FIG. 3, the time when a temperature of (Tg−70°) C has been reached during temperature increase is represented as t1, the time when a temperature of (Tg−70°) C has been reached during temperature decrease is represented as t2, and the time from t1 to t2 is represented as tx. In FIG. 3, as compared to FIG. 2, the time for which the constant temperature is held is shorter and the rate of temperature decrease is slower. In FIG. 3, the time (tx) for which the glass is subjected to heat treatment at temperatures of not lower than (Tg−70°) C and not higher than (Tg+40°) C is six or more hours.

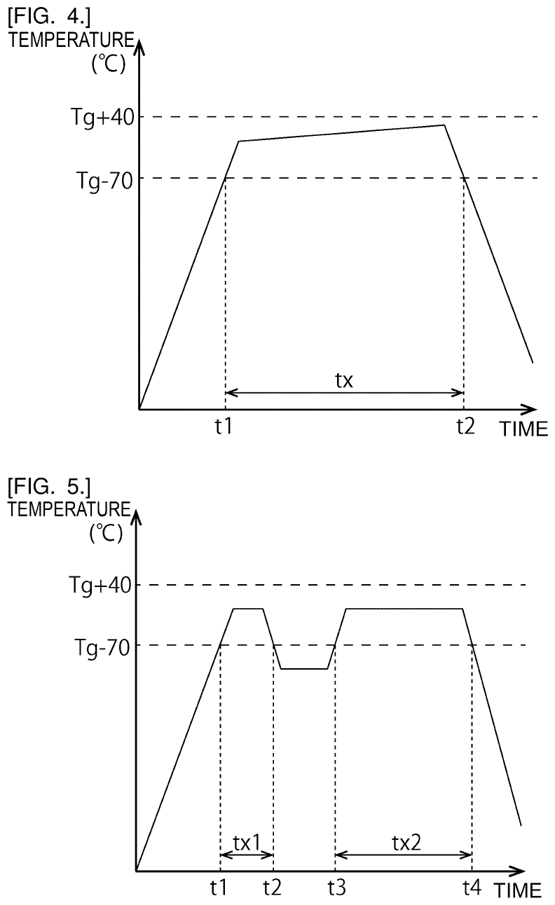

FIG. 4 is a graph showing a third example of a time chart of heating temperature applicable in subjecting a glass to heat treatment in the present invention.

In FIG. 4, the glass is heated at a constant rate of temperature increase (a first rate of temperature increase), then further heated at a constant rate of temperature increase (a second rate of temperature increase), and then cooled at a constant rate of temperature decrease. In FIG. 4, the time when a temperature of (Tg−70°) C has been reached during temperature increase is represented as t1, the time when a temperature of (Tg−70°) C has been reached during temperature decrease is represented as t2, and the time from t1 to t2 is represented as tx. In FIG. 4, the time (tx) for which the glass is subjected to heat treatment at temperatures of not lower than (Tg−70°) C and not higher than (Tg+40°) C is six or more hours.

FIG. 5 is a graph showing a fourth example of a time chart of heating temperature applicable in subjecting a glass to heat treatment in the present invention.

In FIG. 5, the glass is heated at a constant rate of temperature increase (a first rate of temperature increase), then held at a constant temperature, and then cooled at a constant rate of temperature decrease (a first rate of temperature decrease). Then, the glass is held at a constant temperature. Then, the glass is heated at a constant rate of temperature increase (a second rate of temperature increase), then held at a constant temperature, and then cooled at a constant rate of temperature decrease (a second rate of temperature decrease). In FIG. 5, the time when a temperature of (Tg−70°) C has been reached during the first temperature increase is represented as t1, the time when a temperature of (Tg−70°) C has been reached during the first temperature decrease is represented as t2, the time when a temperature of (Tg−70°) C has been reached during the second temperature increase is represented as t3, and the time when a temperature of (Tg−70) ° C. has been reached during the second temperature decrease is represented as t4. Furthermore, in FIG. 5, the time from t1 to t2 is represented as tx1 and the time from t3 to t4 is represented as tx2. In FIG. 5, each of the time (tx1) and the time (tx2) is less than six hours. In FIG. 5, the total time of the time (tx1) and the time (tx2) is six or more hours. Like this, the glass may be subjected to heat treatment discontinuously for six or more hours at temperatures of not lower than (Tg−70°) C and not higher than (Tg+40° C.)

Each of the above-described rate of temperature increase and rate of temperature decrease is not particularly limited. The rate of temperature increase may be, for example, not lower than 1° C./min, preferably not lower than 5° C./min, not higher than 20° C./min, and preferably not higher than 10° C./min. The rate of temperature decrease may be, for example, not lower than 0.1° C./min, preferably not lower than 0.13° C./min, more preferably not lower than 0.15° C./min, not higher than 10° C./min, preferably not higher than 5° C./min, and more preferably not higher than 1° C./min.

The above step of subjecting to heat treatment can be performed, for example, using an electric furnace in an atmospheric environment.

### (Glass and Glass Material)

Each of a glass (precursor glass) prepared in the method for producing a glass material according to the present invention and a glass material according to the present invention preferably contains, in terms of % by mole, not less than 50% La₂O₃+Gd₂O₃+Y₂O₃+Yb₂O₃+Ga₂O₃+TiO₂+ZrO₂+Nb₂O₅+Ta₂O₅+WO₃ and not more than 50% B₂O₃+SiO₂+P₂O₅+GeO₂. Although a conventional glass material having the above composition is likely to undergo solarization, the present invention enables even a glass material having the above composition to be less likely to undergo solarization.

Normally, the composition of the above prepared glass is the same as the composition of a glass material obtained by subjecting the glass to the heat treatment.

In the present specification, “%” in the following description of the respective contents of components refers to “% by mole” unless otherwise specified. Furthermore, herein, “x+y+ . . . ” means the total sum of the contents of the relevant components. Note that the content of at least one of the relevant components in “x+y+ . . . ” may be 0%. The word “to” used herein in terms of range of values means that the values described on both sides of the word are also included as the lower limit and the upper limit in the range of values.

In the present specification, the types and contents of preferred components described below correspond to those of the glass to be prepared in the method for producing a glass material according to the present invention and those of the glass material according to the present invention.

The content of La₂O₃+Gd₂O₃+Y₂O₃+Yb₂O₃+Ga₂O₃+TiO₂+ZrO₂+Nb₂O₅+Ta₂O₅+WO₃ is preferably not less than 50%, more preferably 55 to 100%, still more preferably 60 to 95%, and particularly preferably 63 to 90%. If in the conventional glass material the total content of these components is too large, solarization is likely to occur. However, in the present invention, solarization can be less likely to occur even when the total content of these components is large.

La₂O₃ is a component that increases the refractive index and increases the stability of vitrification. The content of La₂O₃ is preferably 10% or more, more preferably 15 to 70%, still more preferably 20 to 65%, and particularly preferably 25 to 63%. If the content of La₂O₃ is too small, the above effects are less likely to be obtained. On the other hand, if the content of La₂O₃ is too large, vitrification may be less likely to occur.

Gd₂O₃ is also a component that increases the refractive index and increases the stability of vitrification. The content of Gd₂O₃ is preferably 0 to 30%, more preferably 5 to 25%, and still more preferably 10 to 20%. If the content of Gd₂O₃ is too large, vitrification may be less likely to occur.

Y₂O₃ is a component that increases the refractive index. The content of Y₂O₃ is preferably 0 to 30%, more preferably 1 to 20%, and still more preferably 5 to 15%. If the content of Y₂O₃ is too large, vitrification may be less likely to occur.

Yb₂O₃ is also a component that increases the refractive index. The content of Yb₂O₃ is preferably 0 to 20%, more preferably 1 to 15%, and still more preferably 3 to 10%. If the content of Yb₂O₃ is too large, devitrification and striae are likely to occur.

Ga₂O₃ is a component that increases the glass formation ability. The content of Ga₂O₃ is preferably 0 to 50%, more preferably 10 to 45%, and still more preferably 20 to 40%. If the content of Ga₂O₃ is too large, devitrification is likely to occur.

TiO₂ is a component that increases the refractive index and also a component that increases the chemical durability. The content of TiO₂ is preferably 0 to 86%, more preferably 5 to 75%, still more preferably 10 to 50%, and particularly preferably 15 to 40%. If the content of TiO₂ is too large, devitrification is likely to occur.

ZrO₂ is a component that increases the refractive index and the chemical durability. The content of ZrO₂ is preferably 0 to 30%, more preferably 5 to 20%, and still more preferably 10 to 18%. If the content of ZrO₂ is too large, devitrification is likely to occur.

Nb₂O₅ is a component having a large effect to increase the refractive index and also a component having an effect to extend the vitrification range. Nb₂O₅ is also a component having an effect to lower the glass transition point. The content of Nb₂O₅ is preferably 0 to 80%, more preferably 5 to 70%, and still more preferably 10 to 60%. If the content of Nb₂O₅ is too large, vitrification may be less likely to occur.

Ta₂O₅ is a component that increases the refractive index. The content of Ta₂O₅ is preferably 0 to 50%, more preferably 1 to 45%, and still more preferably 5 to 40%. If the content of Ta₂O₅ is too large, phase separation and devitrification are likely to occur. Furthermore, because Ta₂O₅ is a rare and expensive component, an increase in the content thereof leads to an increase in the raw material cost.

WO₃ is a component that increases the refractive index. The content of WO₃ is preferably 0 to 30%, more preferably 1 to 20%, and still more preferably 5 to 10%. If the content of WO₃ is too large, it may absorb light in the visible range to decrease the transmittance.

The content of B₂O₃+SiO₂+P₂O₅+GeO₂ is preferably 0 to 50%, more preferably 5 to 45%, still more preferably 10 to 40%, and particularly preferably 15 to 37%. When the total content of these components is within the above range, the effects of the present invention can be more effectively exerted.

B₂O₃ is a component that forms a glass network and has an effect to extend the vitrification range. Furthermore, B₂O₃ is also a component having an effect to lower the glass transition point. The content of B₂O₃ is preferably 0 to 50%, more preferably 5 to 40%, and still more preferably 10 to 37%. If the content of B₂O₃ is too large, the refractive index may decrease to make it less likely that desired optical properties are obtained.

SiO₂ is a component that forms a glass network and has an effect to extend the vitrification range. Furthermore, SiO₂ is also a component having an effect to increase the weather resistance. The content of SiO₂ is preferably 0 to 25%, more preferably 5 to 20%, and still more preferably 10 to 15%. If the content of SiO₂ is too large, the refractive index may decrease to make it less likely that desired optical properties are obtained.

P₂O₅ is a component that forms a glass network and has an effect to extend the vitrification range. The content of P₂O₅ is preferably 0 to 20% and more preferably 5 to 10%. If the content of P₂O₅ is too large, phase separation is likely to occur.

GeO₂ is a component that increases the refractive index and also a component having an effect to extend the vitrification range. The content of GeO₂ is preferably 0 to 20%, more preferably 1 to 10%, and still more preferably 3 to 5%. If the content of GeO₂ is too large, the raw material cost tends to be high.

Each of the above-described glass and glass material may contain other components in addition to the above-described components. Examples of the other components include Al₂O₃, RO (R: at least one selected from among Zn, Mg, Ca, Sr, and Ba), R′₂O (R′: at least one selected from among Li, Na, and K), and RE₂O₃(RE: at least one selected from among Pr, Nd, Eu, Tb, Dy, Ho, Er, Tm, and Lu). The other components may be used singly or in a combination of two or more of them.

Al₂O₃ is a component having an effect to extend the vitrification range. Furthermore, Al₂O₃ is also a component having an effect to increase the weather resistance. The content of Al₂O₃ is preferably 0 to 30%, more preferably 1 to 20%, and still more preferably 5 to 10%. If the content of Al₂O₃ is too large, vitrification may be less likely to occur.

RO (R: at least one selected from among Zn, Mg, Ca, Sr, and Ba) is a component having an effect to extend the vitrification range. Furthermore, the component also has an effect to increase the weather resistance. The content of each of these components is preferably 0 to 10%, more preferably 0.1 to 5%, and still more preferably 1 to 3%. If the content of each of these components is too large, the refractive index decreases to make it less likely that desired optical properties are obtained.

R′₂O (R′: at least one selected from among Li, Na, and K) is a component having an effect to lower the melting point of glass and extend the vitrification range. The content of each of these components is preferably 0 to 10% and more preferably 1 to 5%. If the content of each of these components is too large, the weather resistance decreases and the refractive index decreases to make it less likely that desired optical properties are obtained.

RE₂O₃ (RE: at least one selected from among Pr, Nd, Eu, Tb, Dy, Ho, Er, Tm, and Lu) is a component that increases the refractive index. The content of each of these components is preferably 0 to 1% and more preferably 0 to 0.5%. If the content of each of these components is too large, vitrification is less likely to occur.

In the glass material according to the present invention, when the glass material is subjected to light irradiation of light having a wavelength of 280 nm to 400 nm at an irradiance of 0.1 mW/cm² to 10 mW/cm² for 24 hours to 100 hours, the absolute value Δb* of a difference between the chromaticity b* (a first chromaticity b*) of the glass material before the light irradiation in the L*a*b* color system and the chromaticity b* (a second chromaticity b*) of the glass material after the light irradiation in the L*a*b* color system is preferably 0.5 or less.

The conditions of the above light irradiation are preferably conditions where the glass material is irradiated with light having a wavelength of 310 nm to 380 nm at an irradiance of 0.1 mW/cm² to 1 mW/cm² for 24 hours to 100 hours. The conditions of the above light irradiation are more preferably conditions where the glass material is irradiated with light having a central wavelength of 313 nm at an irradiance of 0.3 mW/cm² and light having a central wavelength of 365 nm at an irradiance of 0.3 mW/cm² for 24 hours to 100 hours. The conditions of the above light irradiation are still more preferably conditions where the glass material is irradiated with light having a central wavelength of 313 nm at an irradiance of 0.3 mW/cm² and light having a central wavelength of 365 nm at an irradiance of 0.3 mW/cm² for 100 hours. The above-described “light having a central wavelength of 313 nm at an irradiance of 0.3 mW/cm² and light having a central wavelength of 365 nm at an irradiance of 0.3 mW/cm²” are preferably applied concurrently to the glass material.

The shape and so on of the glass material subjected to the light irradiation are not particularly limited.

Each of the above first chromaticity b* and second chromaticity b* can be determined by measuring the spectral transmittance of the glass material and calculating the chromaticity b* from a transmittance curve obtained by the measurement.

The magnitude relation between the first chromaticity b* and the second chromaticity b* is not particularly limited, but, normally, the first chromaticity b* is smaller than the second chromaticity b*.

The second chromaticity b* is preferably 2.0 or less, more preferably 1.7 or less, still more preferably 1.5 or less, and particularly preferably 1.4 or less.

The absolute value Δb* of a difference between the first chromaticity b* and the second chromaticity b* is preferably 0.5 or less, more preferably 0.3 or less, and still more preferably 0.2 or less. The smaller the absolute value Δb* of the difference the more preferable. As the absolute value Δb* of the difference is smaller, solarization can be more effectively prevented.

The refractive index of the glass material is preferably not less than 1.8, more preferably not less than 1.9, still more preferably not less than 2.0, preferably not more than 2.4, and more preferably not more than 2.3.

The refractive index is indicated by a measured value for the d-line (587.6 nm) of a helium lamp.

The glass material according to the present invention can be suitably produced by the method for producing a glass material described previously. The glass material according to the present invention is preferably an optical glass material.

Hereinafter, a description will be given in further detail of the present invention with reference to specific examples, but the present invention is not at all limited by the following examples, and modifications and variations may be appropriately made therein without changing the gist of the invention.

### Examples 1 to 17 and Comparative Examples 1 to 11

The respective compositions and results of the glass materials produced in Examples 1 to 17 and Comparative Examples 1 to 11 are shown in Tables 1 to 3.

TABLE 1

| | | | | | | | | | Comp. | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 1 | Ex. 2 |
| Class Composition of | La₂O₃ | 30 | 30 | 30 | 30 | 30 | 30 | 30 | 30 | 30 |
| Precursor Glass and | Nb₂O₅ | 60 | 60 | 60 | 60 | 60 | 60 | 60 | 60 | 60 |
| Glass Material | B₂O₃ | 10 | 10 | 10 | 10 | 10 | 10 | 10 | 10 | 10 |
| (% by mole) | | | | | | | | | | |
| Glass Transistion Point Tg | | 690 | 690 | 690 | 690 | 690 | 690 | 690 | 690 | 690 |
| of Precursor Glass (° C.) | | | | | | | | | | |
| Heat Treatment | Rate of Temperature | 5 | 5 | 5 | 10 | 5 | 5 | 1 | 5 | 5 |
| Conditions | Increase (° C./min) | | | | | | | | | |
| | Time for Temperature | 0.27 | 0.27 | 0.27 | 0.13 | 0.27 | 0.27 | 1.67 | 0.27 | 0.33 |
| | Increase (h) ※ | | | | | | | | | |
| | Maximum Temperature | 700 | 700 | 700 | 700 | 700 | 700 | 720 | 700 | 720 |
| | (° C.) | | | | | | | | | |
| | Holding Time at | 24 | 24 | 12 | 12 | 6 | 0.5 | 0.5 | 0.5 | 1 |
| | Maximum Temperature (h) | | | | | | | | | |
| | Rate of Temperature | 10 | 0.5 | 5 | 1.5 | 10 | 0.15 | 0.13 | 10 | 0.5 |
| | Decrease (° C./min) | | | | | | | | | |
| | Time for Temperature | 0.13 | 2.67 | 0.27 | 0.89 | 0.13 | 8.89 | 12.82 | 0.13 | 3.33 |
| | Decrease (h) ※ | | | | | | | | | |
| | Time for Heat Treatment | 24.4 | 26.94 | 12.54 | 13.02 | 6.4 | 9.66 | 14.99 | 0.9 | 4.66 |
| | at Temperature of | | | | | | | | | |
| | (Tg − 70)° C. to | | | | | | | | | |
| | (Tg + 40)° C. (h) | | | | | | | | | |
| Before Light Irradiation | First Chromaticity b* | 1.10 | 1.04 | 1.06 | 1.14 | 1.13 | 1.10 | 1.12 | 1.01 | 1.12 |
| | of Glass Material | | | | | | | | | |
| After Light Irradiation | Second Chromaticity b* | 1.37 | 1.20 | 1.31 | 1.21 | 1.56 | 1.58 | 1.58 | 2.04 | 1.80 |
| | of Glass Material | | | | | | | | | |
| Before and After Light | Absolute Value Δb* of | 0.27 | 0.16 | 0.25 | 0.07 | 0.43 | 0.48 | 0.46 | 1.03 | 0.68 |
| Irradiation | Difference | | | | | | | | | |

※ Time for Temperature Increase/Temperature Decrease = Time Taken to Rise from (Tg − 70)° C. to Maximum Temperature or Drop Reversely

TABLE 2

| | | Ex. | Ex. | Comp. | Ex. | Comp. | Ex. | Comp. | Ex. | Comp. |
|---|---|---|---|---|---|---|---|---|---|---|
| | | 8 | 9 | Ex. 3 | 10 | Ex. 4 | 11 | Ex. 5 | 12 | Ex. 6 |
| Class Composition of | La₂O₃ | 30 | 30 | 30 | 25 | 25 | 43 | 43 | 53 | 53 |
| Precursor Glass and | Nb₂O₅ | 70 | 70 | 70 | 38 | 38 | 20 | 20 | 10 | 10 |
| Glass Material | SiO₂ | | | | | | | | 10 | 10 |
| (% by mole) | B₂O₃ | | | | 37 | 37 | 37 | 37 | 27 | 27 |
| Glass Transistion Point Tg | | 725 | 725 | 725 | 640 | 640 | 723 | 723 | 787 | 787 |
| of Precursor Glass (° C.) | | | | | | | | | | |
| Heat Treatment | Rate of Temperature | 5 | 5 | 5 | 5 | 5 | 5 | 5 | 5 | 5 |
| Conditions | Increase (° C./min) | | | | | | | | | |
| | Time for Temperature | 0.23 | 0.32 | 0.22 | 0.27 | 0.27 | 0.26 | 0.26 | 0.24 | 0.24 |
| | Increase (h) ※ | | | | | | | | | |
| | Maximum Temperature | 725 | 750 | 720 | 650 | 650 | 730 | 730 | 790 | 790 |
| | (° C.) | | | | | | | | | |
| | Holding Time at | 12 | 1 | 1 | 12 | 0.5 | 12 | 0.5 | 12 | 0.5 |
| | Maximum Temperature (h) | | | | | | | | | |
| | Rate of Temperature | 10 | 0.15 | 1.5 | 10 | 10 | 10 | 10 | 10 | 10 |
| | Decrease (° C./min) | | | | | | | | | |
| | Time for Temperature | 0.12 | 10.56 | 0.72 | 0.13 | 0.13 | 0.13 | 0.13 | 0.12 | 0.12 |
| | Decrease (h) ※ | | | | | | | | | |
| | Time for Heat Treatment | 12.35 | 11.88 | 1.94 | 12.4 | 0.9 | 12.39 | 0.89 | 12.36 | 0.86 |
| | at Temperature of | | | | | | | | | |
| | (Tg − 70)° C. to | | | | | | | | | |
| | (Tg + 40)° C. (h) | | | | | | | | | |
| Before Light Irradiation | First Chromaticity b* | 1.17 | 1.17 | 1.16 | 0.86 | 0.85 | 1.02 | 1.04 | 0.62 | 0.61 |
| | of Glass Material | | | | | | | | | |
| After Light Irradiation | Second Chromaticity b* | 1.31 | 1.34 | 1.69 | 1.11 | 1.37 | 1.32 | 1.55 | 1.05 | 1.25 |
| | of Glass Material | | | | | | | | | |
| Before and After Light | Absolute Value Δb* of | 0.14 | 0.17 | 0.53 | 0.25 | 0.52 | 0.30 | 0.51 | 0.43 | 0.64 |
| Irradiation | Difference | | | | | | | | | |

※ Time for Temperature Increase/Temperature Decrease = Time Taken to Rise from (Tg − 70)° C. to Maximum Temperature or Drop Reversely

TABLE 3

| | | Ex. | Comp. | Ex. | Comp. | Ex. | Comp. | Ex. | Comp. | Ex. | Comp. |
|---|---|---|---|---|---|---|---|---|---|---|---|
| | | 13 | Ex. 7 | 14 | Ex. 8 | 15 | Ex. 9 | 16 | Ex. 10 | 17 | Ex. 11 |
| Class Composition of | La₂O₃ | 51.6 | 51.6 | 30 | 30 | 20 | 20 | 30 | 30 | 30 | 30 |
| Precursor Glass and | Nb₂O₅ | | | 50 | 50 | 50 | 50 | 40 | 40 | | |
| Glass Material | Ta₂O₅ | | | | | | | | | 40 | 40 |
| (% by mole) | TiO₂ | 14 | 14 | | | | | | | | |
| | Ga₂O₃ | | | | | 30 | 30 | 30 | 30 | 30 | 30 |
| | B₂O₃ | 34.4 | 34.4 | 15 | 15 | | | | | | |
| | Al₂O₃ | | | 5 | 5 | | | | | | |
| Glass Transistion Point Tg | | 761 | 761 | 718 | 718 | 686 | 686 | 733 | 733 | 825 | 825 |
| of Precursor Glass (° C.) | | | | | | | | | | | |
| Heat Treatment | Rate of Temperature | 5 | 5 | 5 | 5 | 5 | 5 | 5 | 5 | 5 | 5 |
| Conditions | Increase (° C./min) | | | | | | | | | | |
| | Time for Temperature | 0.23 | 0.23 | 0.24 | 0.24 | 0.28 | 0.28 | 0.32 | 0.32 | 0.28 | 0.28 |
| | Increase (h) ※ | | | | | | | | | | |
| | Maximum Temperature | 760 | 760 | 720 | 720 | 700 | 700 | 760 | 760 | 840 | 840 |
| | (° C.) | | | | | | | | | | |
| | Holding Time at | 12 | 0.5 | 12 | 0.5 | 12 | 0.5 | 12 | 0.5 | 12 | 0.5 |
| | Maximum Temperature (h) | | | | | | | | | | |
| | Rate of Temperature | 10 | 10 | 10 | 10 | 10 | 10 | 10 | 10 | 10 | 10 |
| | Decrease (° C./min) | | | | | | | | | | |
| | Time for Temperature | 0.12 | 0.12 | 0.12 | 0.12 | 0.14 | 0.14 | 0.16 | 0.16 | 0.14 | 0.14 |
| | Decrease (h) ※ | | | | | | | | | | |
| | Time for Heat Treatment | 12.35 | 0.85 | 12.36 | 0.86 | 12.42 | 0.92 | 12.48 | 0.98 | 12.42 | 0.92 |
| | at Temperature of | | | | | | | | | | |
| | (Tg − 70)° C. to | | | | | | | | | | |
| | (Tg + 40)° C. (h) | | | | | | | | | | |
| Before Light Irradiation | First Chromaticity b* | 0.82 | 0.81 | 1.09 | 1.10 | 1.14 | 1.14 | 0.88 | 0.88 | 1.06 | 1.05 |
| | of Glass Material | | | | | | | | | | |
| After Light Irradiation | Second Chromaticity b* | 1.01 | 1.33 | 1.31 | 1.93 | 1.42 | 1.90 | 1.30 | 1.92 | 1.56 | 2.16 |
| | of Glass Material | | | | | | | | | | |
| Before and After Light | Absolute Value Δb* of | 0.19 | 0.52 | 0.22 | 0.83 | 0.28 | 0.76 | 0.42 | 1.04 | 0.50 | 1.11 |
| Irradiation | Difference | | | | | | | | | | |

※ Time for Temperature Increase/Temperature Decrease = Time Taken to Rise from (Tg − 70)° C. to Maximum Temperature or Drop Reversely

In Examples and Comparative Examples, a glass material was produced in the following manner.

First, using a production apparatus similar to that in FIG. 1, a glass (precursor glass) was produced by a containerless levitation technique. Specifically, each of raw material batches formulated to have the respective glass compositions described in Tables 1 to 3 was melted into a homogeneous phase at 1400° C. to 2000° C., thus obtaining a molten glass. Next, the obtained molten glass was rapidly cooled to produce a glass (precursor glass) with a diameter of about 5 mm to about 7 mm. The respective glass transition points Tg of the obtained precursor glasses are as shown in Tables 1 to 3.

Next, using an electric furnace, the obtained precursor glass was subjected to heat treatment under the relevant conditions shown in Tables 1 to 3 in an atmospheric environment. A glass material was obtained in this manner.

The obtained glass material was measured in terms of chromaticity b* (first chromaticity b*) in the L*a*b* color system. Next, using a low-pressure mercury lamp, the obtained glass material was irradiated concurrently with UV light having a central wavelength of 313 nm at an irradiance of 0.3 mW/cm² and UV light having a central wavelength of 365 nm at an irradiance of 0.3 mW/cm² for 100 hours. As for Examples 8 and 9 and Comparative Example 3, the glass material was irradiated likewise for 24 hours. The glass material after the light irradiation was measured in terms of chromaticity b* (second chromaticity b*) in the L*a*b* color system.

The first and second chromaticities b* were determined by measuring the spectral transmittance of the glass material polished to a thickness of 3 mm±0.1 mm and calculating the chromaticity b* in the L*a*b* color system from a transmittance curve obtained by the measurement. Furthermore, the absolute value Δb* of the difference between the first chromaticity b* and the second chromaticity b* was calculated. Among the lightness L*, the chromaticity a*, and the chromaticity b*, the chromaticity b* exhibits largest changes between before and after the light irradiation. Therefore, the chromaticity b* was used as an evaluation item for solarization. The results are shown in Tables 1 to 3.

As is obvious from Tables 1 to 3, the glasses in Examples 1 to 17 were subjected to heat treatment at temperatures of not lower than (Tg−70°) C and not higher than (Tg+40°) C for six or more hours and, therefore, their absolute values Δb* of the differences between before and after the UV light irradiation were 0.5 or less. On the other hand, the heat treatment time of the glasses in Comparative Examples 1 to 11 at temperatures of not lower than (Tg−70) ° C. and not higher than (Tg+40) ° C. was less than six hours and, therefore, their absolute values Δb* of the differences between before and after the UV light irradiation were more than 0.5.

The refractive indices (nd) of the glass materials obtained in Example 1 and Comparative Example 1 were also measured. Specifically, the glass material was bonded onto a 5 mm thick base material made of soda-lime glass plate, then polished at a right angle, and then measured in terms of refractive index with a device “KPR-2000” manufactured by Shimadzu Corporation. The refractive index was evaluated by a measured value for the d-line (587.6 nm) of a helium lamp. As a result, the refractive index of the glass material obtained in Example 1 was 2.212 and the refractive index of the glass material obtained in Comparative Example 1 was 2.211. The glass material obtained in Example 1 was confirmed to have an increased refractive index and a denser structure because of the heat treatment as compared to the glass material obtained in Comparative Example 1.

### REFERENCE SIGNS LIST

1 . . . production apparatus for glass
2 . . . forming mold
2a . . . forming surface
2b . . . gas jet hole
3 . . . gas supply mechanism
4 . . . object to be levitated
5 . . . laser light applicator

1: A method for producing a glass material, the method comprising the steps of:
preparing a glass; and
subjecting the glass to heat treatment for six or more hours at a temperature of not lower than (Tg−70°) C and not higher than (Tg+40°) C where a glass transition point of the glass is represented as Tg (° C.).

2: The method for producing a glass material according to claim 1, wherein the glass contains, in terms of % by mole, not less than 50% La₂O₃+Gd₂O₃+Y₂O₃+Yb₂O₃+Ga₂O₃+TiO₂+ZrO₂+Nb₂O₅+Ta₂O₅+WO₃ and not more than 50% B₂O₃+SiO₂+P₂O₅+GeO₂.

3: The method for producing a glass material according to claim 1, wherein the glass contains, in terms of % by mole, 10% or more La₂O₃.

4: The method for producing a glass material according to claim 1, wherein the step of preparing a glass comprises the steps of:
heating a block of glass raw material held levitated, thus obtaining a molten glass melted from the block of glass raw material by the heating; and
cooling the molten glass to obtain a glass.

5: The method for producing a glass material according to claim 1, the method being a method for producing a glass material for use as an optical glass material.

6: A glass material containing, in terms of % by mole, not less than 50% La₂O₃+Gd₂O₃+Y₂O₃+Yb₂O₃+Ga₂O₃+TiO₂+ZrO₂+Nb₂O₅+Ta₂O₅+WO₃ and not more than 50% B₂O₃+SiO₂+P₂O₅+GeO₂,
wherein, when the glass material is subjected to light irradiation of light having a wavelength of 280 nm to 400 nm at an irradiance of 0.1 mW/cm² to 10 mW/cm² for 24 hours to 100 hours, an absolute value Δb* of a difference between a first chromaticity b* of the glass material before the light irradiation in an L*a*b* color system and a second chromaticity b* of the glass material after the light irradiation in the L*a*b* color system is 0.5 or less.

7: The glass material according to claim 6 containing, in terms of % by mole, 10% or more La₂O₃.

8: The glass material according to claim 6 being an optical glass material.
